(19) United States
(12) Patent Application Publication
(10) Pub. No.: US 2023/0289708 A1
(43) Pub. Date: Sep. 14, 2023

(54) INFORMATION PROCESSING DEVICE, INFORMATION PROCESSING METHOD, AND STORAGE MEDIUM

(71) Applicant: TOYOTA JIDOSHA KABUSHIKI KAISHA, Toyota-shi (JP)

(72) Inventors: Toyokazu NAKASHIMA, Nagoya-shi (JP); Shunsuke SAGARA, Nisshin-shi (JP); Naoya OKA, Nagakute-shi (JP)

(21) Appl. No.: 18/069,441

(22) Filed: Dec. 21, 2022

(30) Foreign Application Priority Data
Mar. 10, 2022 (JP) 2022-037204

(51) Int. Cl. G06Q 10/0833; G06Q 50/26

(52) U.S. Cl. CPC G06Q 10/0833; G06Q 50/26

(57) ABSTRACT

The control unit of the information processing device generates the first information on the basis of an emission amount which is an amount of carbon dioxide predicted to be discharged when each of the plurality of delivery companies delivers a product to a predetermined user by the vehicle. Here, the first information is information including an incentive given to at least one of a plurality of delivery companies or a predetermined user.

### CROSS-REFERENCE TO RELATED APPLICATION

This application claims priority to Japanese Patent Application No. 2022-037204 filed on Mar. 10, 2022, incorporated herein by reference in its entirety.

### BACKGROUND

### 1. Technical Field

The present disclosure relates to an information processing device, an information processing method, and a storage medium.

### 2. Description of Related Art

Japanese Unexamined Patent Application Publication No. 2010-44667 (JP 2010-44667 A) discloses a product specification management server. The product specification management server disclosed in JP 2010-44667 A stores an emission amount identification table in which a cooking method of a product and an emission amount of greenhouse gas when the product is cooked by the cooking method are associated with each other. The product specification management server derives the emission amount of the greenhouse gas related to consumption of each product belonging to a predetermined product group based on the emission amount identification table and the cooking method including cooking contents applicable to the product included in the product specification.

### SUMMARY

An object of the present disclosure is to suppress the amount of carbon dioxide emitted by delivery of a product by a vehicle.

An information processing device according to a first aspect of the present disclosure includes a control unit that executes:
generating first information including an incentive given to at least one of a plurality of delivery companies or an incentive given to a predetermined user based on an emission amount.
The emission amount is an amount of carbon dioxide that is expected to be emitted when each of the delivery companies delivers a product to the predetermined user by a vehicle.

An information processing method according to a second aspect of the present disclosure is an information processing method executed by a computer, and includes:
generating first information including an incentive given to at least one of a plurality of delivery companies or an incentive given to a predetermined user based on an emission amount.
The emission amount is an amount of carbon dioxide that is expected to be emitted when each of the delivery companies delivers a product to the predetermined user by a vehicle.

A storage medium according to a third aspect of the present disclosure is a storage medium storing a program for causing a computer to execute an information processing method, and the information processing method includes:
generating first information including an incentive given to at least one of a plurality of delivery companies or an incentive given to a predetermined user based on an emission amount.
The emission amount is an amount of carbon dioxide that is expected to be emitted when each of the delivery companies delivers a product to the predetermined user by a vehicle.

According to the present disclosure, it is possible to suppress the amount of carbon dioxide emitted by the delivery of the product by the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing the schematic configuration of the delivery system.

FIG. 2 is a diagram illustrating an example of a selection screen displayed on a user terminal;

FIG. 3 is a diagram schematically illustrating an exemplary functional configuration of a delivery server and an EC server;

FIG. 4 is a diagram illustrating an example of a table configuration of history information held in a history information database;

FIG. 5 is a diagram illustrating an example of a table configuration of the emission amount information held in the emission amount information database;

FIG. 6 is a diagram illustrating an example of a table configuration of the delivery company information held in the delivery company information database according to the first embodiment;

FIG. 7 is a sequence diagram illustrating a flow of information processing in the delivery system.

FIG. 8 is a flowchart of a generation process;

FIG. 9 is a diagram illustrating an exemplary table configuration of the delivery company information held in the delivery company information database according to the second embodiment; and

FIG. 10 is a flowchart of the assigning process.

### DETAILED DESCRIPTION OF EMBODIMENTS

It is assumed that when a user requests delivery of a product, a delivery company requesting delivery of the product is determined from a plurality of delivery companies. Here, the plurality of delivery companies delivers the commodity by the vehicle. In this case, it is assumed that the amount of carbon dioxide discharged by the vehicle when the product is delivered to the user is different for each of the plurality of delivery companies.

Therefore, the control unit of the information processing device according to the first aspect of the present disclosure generates the first information on the basis of the amount of carbon dioxide (hereinafter, sometimes referred to as “predicted emission amount”) predicted to be discharged when each of the plurality of delivery companies delivers a product to a predetermined user by the vehicle. Here, the first information is information including an incentive given to at least one of the plurality of delivery companies. Further, the first information may be information including an incentive given to a predetermined user.

As described above, the information processing device according to the first aspect of the present disclosure generates the first information based on the predicted emission amount. Here, in a case where the first information is information including an incentive given to at least one of the plurality of delivery companies, it is possible to encourage the plurality of delivery companies to take measures to suppress the amount of carbon dioxide discharged for delivery of the commodity by the vehicle. In addition, when the first information is information including an incentive given to a predetermined user, it is possible to prompt the predetermined user to select a delivery company having a small predicted emission amount when selecting a delivery company requesting delivery of a product.

As described above, by generating the first information by the information processing device according to the first aspect of the present disclosure, it is possible to suppress the amount of carbon dioxide discharged by the delivery of the commodity by the vehicle.

Hereinafter, embodiments of the present disclosure will be described below with reference to the drawings. Unless otherwise specified, dimensions, materials, shapes, relative arrangements, and the like of components described in the present embodiments are not intended to limit the technical scope of the present disclosure to those alone.

### First Embodiment

System Overview

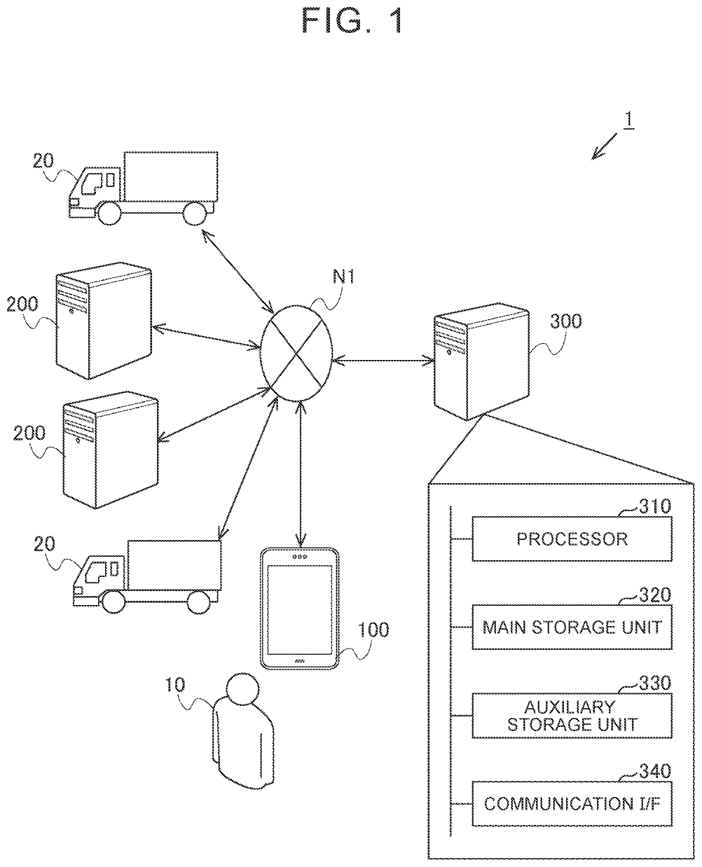

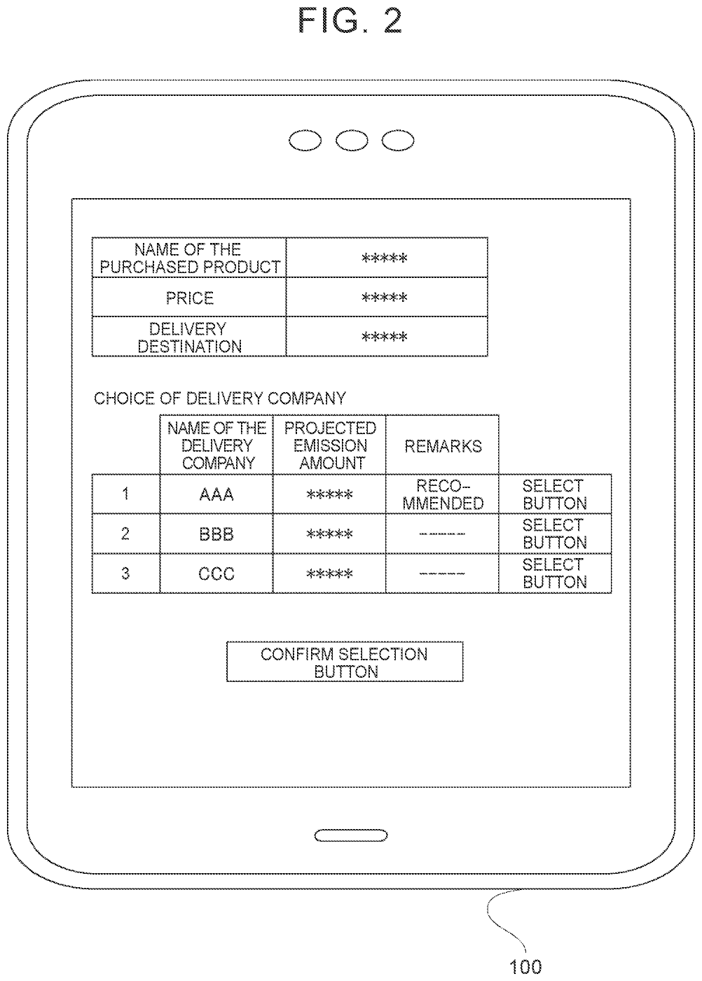

The delivery system 1 according to the present embodiment will be described with reference to FIGS. 1 and 2. FIG. 1 is a diagram showing the schematic configuration of the delivery system 1. The delivery system 1 includes a user terminal 100, a plurality of delivery vehicles 20, a plurality of delivery servers 200, and an EC server 300. In the delivery system 1, a user terminal 100, a plurality of delivery vehicles 20, a plurality of delivery servers 200, and an EC server 300 are connected to each other via a network N1.

Delivery Vehicles

The delivery vehicle 20 is a vehicle for delivering a package. The delivery vehicle 20 is managed by any one of a plurality of delivery companies. The delivery vehicles transmit and receive various types of data to and from the delivery servers 200 via a network N1.

Delivery Server

The delivery server 200 is a server that manages delivery of a package by the delivery vehicle 20. Each delivery server 200 manages at least one delivery vehicle 20 among the plurality of delivery vehicles 20. Further, each delivery server 200 is managed by one of a plurality of delivery companies. Each delivery server 200 receives delivery information from a managed delivery vehicle 20. Here, the delivery information is information on a plurality of packages delivered by the delivery vehicle 20 and a distance traveled when the plurality of packages are delivered. Further, based on the delivery information received from the delivery vehicle 20, the delivery server 200 calculates the emission amount of carbon dioxide that is predicted to be discharged when the package is delivered to the user 10. Details of a method of calculating the emission amount of carbon dioxide that is predicted to be discharged when the delivery server 200 delivers the package to the user 10 will be described later.

EC Servers

EC server 300 is a server that manages EC sites. EC servers 300 also manage delivery of products purchased at EC websites. EC servers 300 specify, for each of the plurality of delivery companies, the amount of carbon dioxide that is predicted to be discharged when the delivery vehicles 20 deliver the products purchased by the user 10 at EC website (hereinafter, may be referred to as “predicted emission amount”). Based on the predicted emission amount for each of the plurality of delivery companies, the EC server 300 generates display information including incentives given to at least one of the plurality of delivery companies. Here, the display information is information displayed on the user terminal 100 when the user 10 selects a delivery company to which the product is delivered from a plurality of delivery companies. A method of the EC server 300 specifying a predicted emission amount for each delivery company and a method of generating display information will be described later. In addition, the display information in the present embodiment corresponds to “first information” according to the present disclosure.

EC servers 300 are configured to include computers. The computer includes a processor 310, a main storage unit 320, an auxiliary storage unit 330, and communication interfaces (communication I/F) 340. The processor 310 is, for example, Central Processing Unit (CPU) or Digital Signal Processor (DSP). The main storage unit 320 is, for example, a Random Access Memory (RAM). The auxiliary storage unit 330 is, for example, a Read Only Memory (ROM). The auxiliary storage unit 330 may be, for example, a hard disk drive (HDD), or a disc recording medium, such as a CD-ROM, a DVD, or a Blu-ray Disc. Further, the auxiliary storage unit 330 may be a removable medium (portable storage medium). Examples of the removable medium include a USB memory or an SD card. The communication I/F 340 is, for example, a Local Area Network (LAN) interface board or wireless communication circuitry for wireless communication.

In the EC server 300, an operating system (OS), various programs, various information tables, and the like are stored in the auxiliary storage unit 330. Further, in EC servers 300, the processor 310 loads the programs stored in the auxiliary storage unit 330 into the main storage unit 320 and executes the programs. As a result, the processor 310 can realize various functions as described later. Part or all of the functions in the EC server 300 may be implemented by a hardware circuit, such as an ASIC and an FPGA. Note that EC servers 300 do not necessarily have to be realized by a single physical configuration. That is, EC servers 300 may be configured by a plurality of computers that cooperate with each other. Note that EC servers 300 in the present embodiment correspond to the “information processing device” according to the present disclosure. Similarly to EC server 300, the delivery vehicles 20 and the delivery server 200 include a computer.

User Terminal

The user terminal 100 is a terminal related to the user 10. The user terminal 100 is, for example, a personal digital assistant or a computer used by the user 10. The user purchases products on EC website by using the user terminal 100 to communicate with EC servers 300 via a network N1. In addition, the user terminal 100 receives the display-information from EC servers 300 via the network N1. Based on the received display information, the user terminal 100 displays a screen (hereinafter, may be referred to as a “selection screen”) for the user 10 to select, from a plurality of delivery companies, a delivery company that delivers the goods purchased at EC website.

FIG. 2 is a diagram illustrating an example of a selection screen displayed on the user terminal 100. As illustrated in FIG. 2, “purchased product name”, “price”, and “delivery destination” are displayed on the selection screen. Here, on the selection screen, information on the name of the product (hereinafter, sometimes referred to as “purchased product”) purchased by the user 10 is displayed as the “purchased product name”. In addition, information on the price of the purchased product is displayed as “price” on the selection screen. Further, on the selection screen, information on the delivery destination of the specific product is displayed as the “delivery destination”.

Further, as shown in FIG. 2, a display for the user 10 to select a delivery company requesting delivery of the purchased product is displayed on the selection screen. In the display for selecting the delivery company, “delivery company name”, “predicted emission amount”, and “remark” are displayed as shown in FIG. 2. Here, the name of each delivery company is displayed as the “delivery company name” on the selection screen. In the embodiment illustrated in FIG. 2, “AAA”, “BBB”, and “CCC” are displayed as the “delivery company name”. In addition, information on the predicted emission amount of each delivery company is input as the “predicted emission amount” to the selection screen. As the information on the predicted emission amount of each delivery company, for example, the weight of carbon dioxide that is predicted to be emitted when the purchased product is delivered is displayed. Further, as the information on the predicted emission amount of each delivery company, for example, a difference between the predicted emission amount (the weight of carbon dioxide) of the reference delivery company and the predicted emission amount (the weight of carbon dioxide) of the other delivery company may be displayed on the basis of one of the plurality of delivery companies. In the example illustrated in FIG. 2, as the information on the predicted emission amount, for example, a difference between the predicted emission amount of “AAA” and the predicted emission amount of “BBB” and a difference between the predicted emission amount of “AAA” and the predicted emission amount of “CCC” may be displayed on the basis of the predicted emission amount of “AAA”.

As described above, in the selection screen, when the user 10 selects a delivery company requesting delivery of the purchased product from a plurality of delivery companies, the predicted emission amount of each delivery company is displayed. Accordingly, the user 10 can select the delivery company based on the predicted emission amount.

Further, in FIG. 2, the predicted emission amounts are shown in the order of “AAA”, “BBB”, and “CCC” in ascending order. Therefore, in the selection window, the “AAA” having the lowest predicted emission amount is displayed above the “BBB” and the “CCC”. In the selection window, the “BBB” having the second smallest predicted emission amount is displayed above the “CCC”. In this way, an incentive that is preferentially displayed on the display screen is given to each delivery company in accordance with the predicted emission amount.

In the present embodiment, the incentive to be preferentially displayed on the display screen is that the display position is displayed upward in accordance with the predicted emission amount. However, the incentive that is preferentially displayed on the display screen does not necessarily have to be displayed at an upper position in accordance with the predicted emission amount. The incentive to be preferentially displayed on the display screen may be, for example, a large display of the delivery company on the display screen (a large size of a character indicating the delivery company). As described above, the display position is displayed upward or the delivery company is displayed in a large size, so that the delivery company to which the incentive is given is easily requested to be delivered by the user 10.

Further, as shown in FIG. 2, “Recommendation” is displayed for “AAA” as “Remarks”. As described above, in the selection window, the user 10 is displayed to propose an “AAA” having the smallest predicted emission amount as a delivery company that recommends requesting delivery of the purchased product. In this way, when the predicted emission amount is the smallest, an incentive is given to propose a delivery company that recommends requesting delivery of the purchased product.

In the present embodiment, it is proposed as a delivery company that recommends requesting delivery of a purchased product to a delivery company having the smallest predicted emission amount. However, it is not always necessary to provide an incentive to be proposed as a delivery company that recommends requesting delivery of a purchased product only to a delivery company that has the lowest predicted emission amount. For example, an incentive may be given to a predetermined number of delivery companies, among the plurality of delivery companies, whose predicted emission amounts are smaller than those of the other delivery companies, to be proposed as a delivery company that recommends requesting delivery of the purchased product. This makes it easier for the delivery company that has been given the incentive to be requested for delivery by the user 10.

Further, as shown in FIG. 2, a “selection button” is displayed on the selection screen. When the user 10 presses the “selection button” on the selection screen, it is possible to select a delivery company that requests delivery of a purchased product among a plurality of delivery companies. Further, as shown in FIG. 2, a “selection confirmation button” is displayed on the selection screen. When the user 10 presses the “selection confirmation button” on the selection screen, the selected delivery company can be confirmed as a delivery company requesting delivery of the purchased product. When the delivery company requesting delivery of the purchased product is determined, the user terminal 100 transmits selection information to the delivery server 200. Here, the selection information is information indicating a delivery company to which the user 10 requests delivery of the purchased product.

Functional Configuration

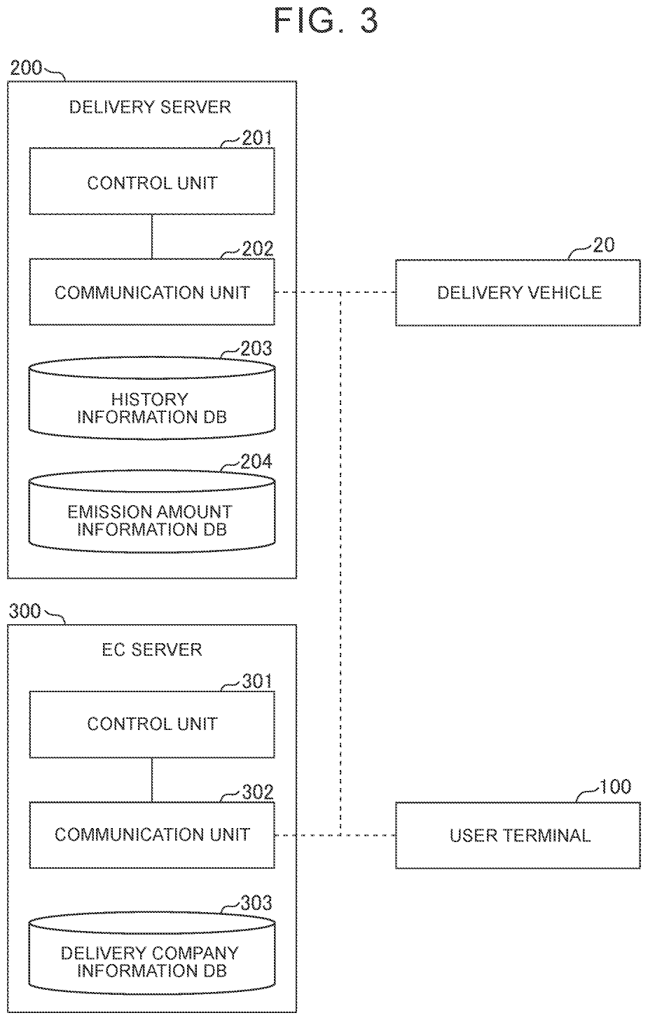

Next, the functional configurations of the delivery server 200 and EC server 300 constituting the delivery system 1 will be described with reference to FIG. 3 to FIG. 6. FIG. 3 is a diagram schematically illustrating an exemplary functional configuration of the delivery server 200 and EC server 300.

Delivery Server

The delivery servers 200 are configured to include a control unit 201, a communication unit 202, a history information database 203 (history information DB 203), and an emission amount information database 204 (emission amount information DB 204). The control unit 201 has a function of executing an arithmetic process required for controlling the delivery server 200. The control unit 201 can be realized by a processor in the delivery server 200. The communication unit 202 has a function of connecting the delivery servers 200 to a network N1. The communication unit 202 can be realized by a communication I/F in the delivery servers 200.

The history information DB 203 has a function of holding history information. The history information is information related to a delivery history of the delivery vehicle 20 under the management of the delivery server 200. The history-information DB 203 can be realized by the auxiliary storage unit in the delivery server 200.

The control unit 201 receives the delivery information from the delivery vehicle 20 managed by the delivery server 200 by the communication unit 202. The control unit 201 updates the history information held in the history information DB 203 on the basis of the information on the plurality of packages delivered by the delivery vehicle 20 and the distance traveled when the plurality of packages were delivered. Information on a plurality of packages delivered by the delivery vehicle 20 and a distance traveled when the plurality of packages are delivered is included in the delivery information.

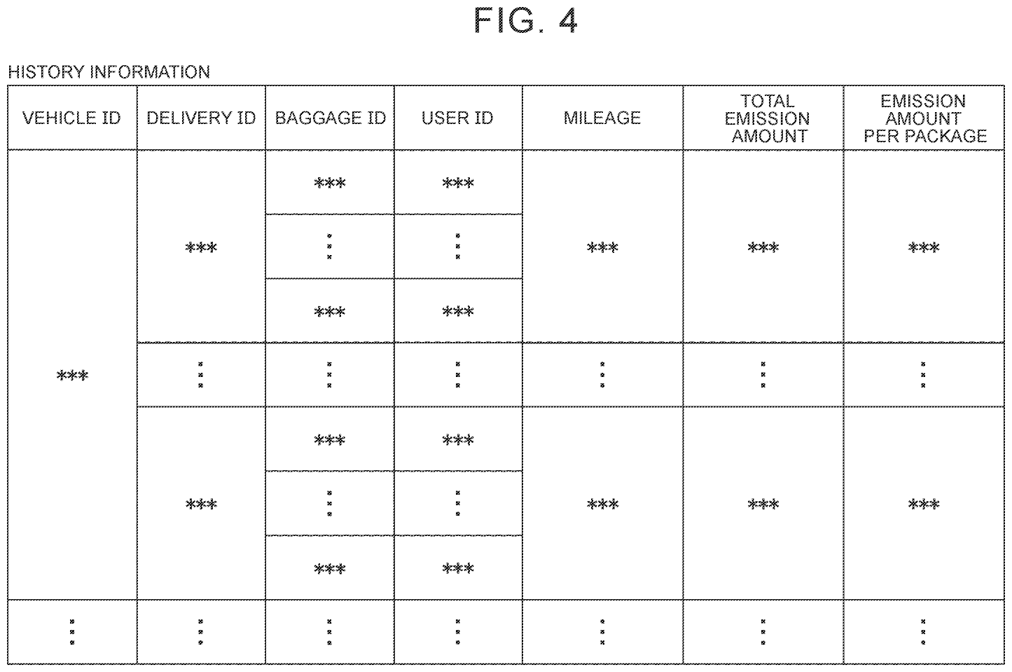

FIG. 4 is a diagram illustrating an exemplary table configuration of the history information held in the history information DB 203. As shown in FIG. 4, the historical data includes a vehicle ID field, a delivery ID field, a package ID field, a user ID field, a mileage field, a total emission amount field, and an emission amount field per package. In the vehicle ID field, an identifier (vehicle ID) for specifying the delivery vehicle 20 is inputted. Here, the vehicle ID of the delivery vehicle 20 managed by the delivery server 200 is inputted to the vehicle ID field of the history information held in the history information DB 203.

In the delivery ID field, an identifier (delivery ID) for specifying a delivery operation by the delivery vehicle 20 corresponding to the vehicle ID input in the vehicle ID field is input. The delivery ID is assigned to each delivery operation until the delivery vehicle departs from the collection station of the package, the delivery of the package assigned to the delivery vehicle 20 is performed, and the delivery vehicle 20 returns to the collection station.

In the package ID field, an identifier (package ID) for specifying a package to be delivered by the delivery vehicles 20 in the delivery operation corresponding to the delivery ID input in the delivery ID field is input. In the user ID field, an identifier (user ID) for specifying the recipient of the package corresponding to the package ID input in the package ID field is input.

In the travel distance field, the travel distance of the delivery vehicles 20 at the time of performing the delivery operation corresponding to the delivery ID input in the delivery ID field is input. In the total emission amount field, the amount of carbon dioxide (total emission amount) discharged when the delivery vehicle 20 corresponding to the vehicle ID that is input to the vehicle ID field is driven by the travel distance input to the travel distance field is input. The control unit 201 calculates the total emission amount by multiplying the amount of carbon dioxide emitted by the delivery vehicle 20 per unit distance by the travel distance.

In the emission amount field per package, a value obtained by dividing the total emission amount input in the total emission amount field by the number of packages delivered in the delivery operation corresponding to the delivery ID input in the delivery ID field is input.

The emission amount information DB 204 has a function of holding emission amount information. The emission amount information is information on the amount of carbon dioxide that is estimated to have been discharged in order for the delivery vehicle 20 to deliver one package in the past. The emission amount-information DB 204 can be realized by the auxiliary storage unit in the delivery server 200.

The control unit 201 acquires all emission amounts per package for each user ID in the history data. Then, the control unit 201 calculates an average value of the emission amounts per all the packages for each user ID, and acquires the calculated average value as the average emission amount. Here, it is assumed that the emission amount per package is the amount of carbon dioxide discharged by the delivery vehicles 20 when the package is delivered to the recipient of the package corresponding to the user ID. Therefore, the average value of the emission amount per package is the amount of carbon dioxide that is estimated to have been discharged in order for the delivery vehicle 20 to deliver a package in the past. Therefore, the control unit 201 generates the emission amount data based on the calculated mean emission amount for each user ID. The control unit 201 stores the emission amount information in the emission amount information DB 204.

FIG. 5 is a diagram illustrating an exemplary table configuration of the emission amount information held in the emission amount information DB 204. As shown in FIG. 5, the emissions amount data includes a user ID field, a package ID field, an emission amount field, and a mean emission amount field. In the user ID field, the user ID entered in the user ID field of the history data is entered. In the package ID field, the package ID of the package delivered to the user entered in the user ID field is inputted based on the history data. In the emission amount field, based on the history information, the emission amount per package corresponding to the package ID input in the package ID field is input. In the average emission amount field, the average value (average emission amount) of the emission amount input in the emission amount field is input for each user ID input in the user ID field.

EC Servers

EC servers 300 are configured to include a control unit 301, a communication unit 302, and a delivery company information database 303 (delivery company information DB 303). The control unit 301 has a function of executing an arithmetic process required for controlling the EC server 300. The control unit 301 can be implemented by the processor 310 in EC servers 300. The communication unit 302 has a function of connecting EC servers 300 to a network N1. The communication unit 302 can be realized by a communication I/F 340 in EC servers 300.

The control unit 301 receives the emission amount information from each delivery server 200 by the communication unit 302. Based on the emission amount information received from each delivery server 200, the control unit 301 generates delivery company information regarding the average emission amount for each delivery company. The control unit 301 stores the delivery company information in the delivery company information DB 303. The delivery company information DB 303 has a function of holding delivery company information. The delivery company information DB 303 can be realized by the auxiliary storage unit 330 in EC servers 300.

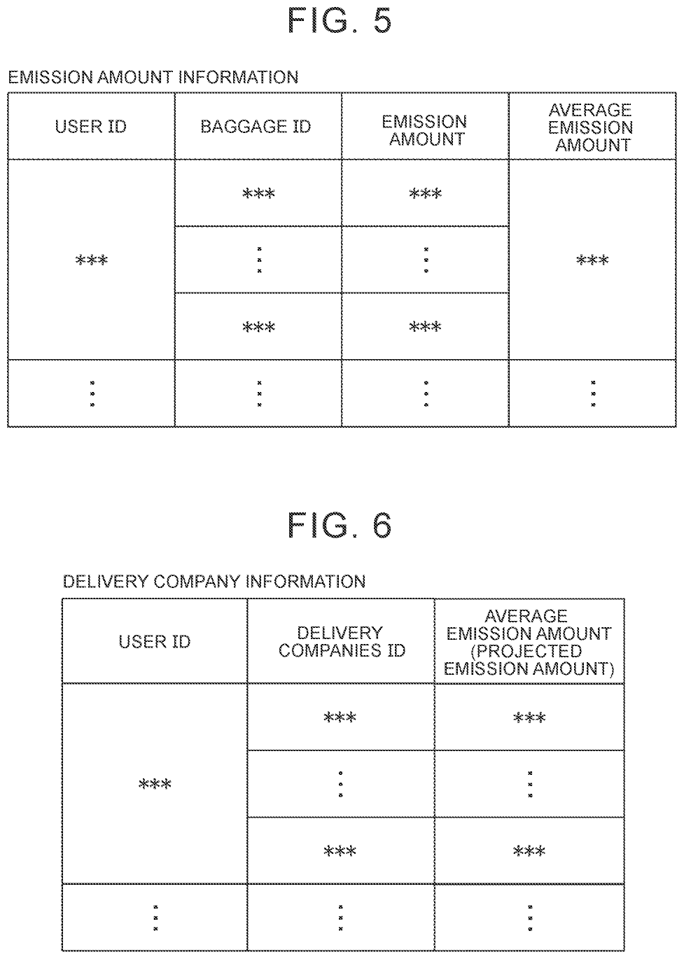

FIG. 6 is a diagram illustrating an exemplary table configuration of the delivery company information held in the delivery company information DB 303 according to the present embodiment. As shown in FIG. 6, a user ID field, a delivery company ID field, and a mean emission amount field are included in the delivery company information. User ID included in the emission amount data received from the respective delivery servers 200 are inputted to the user ID fields. In the user ID, the delivery companies use the same ID. That is, the user ID of the same person has the same ID. In the delivery company ID field, an identifier (delivery company ID) for specifying a delivery company is inputted. In the average emission amount field, the average emission amount included in the delivery company information is input for each delivery company corresponding to the delivery company ID input in the delivery company ID field.

Here, the average emission amount is an amount of carbon dioxide that is estimated to be discharged by the delivery vehicle 20 when the delivery vehicle 20 managed by the delivery company corresponding to the delivery company ID inputted to the delivery company ID has previously delivered the package to the recipient of the package corresponding to the user ID. Therefore, it can be assumed that the average emission amount is the amount of carbon dioxide that the delivery vehicle 20 is expected to emit to deliver one package. That is, it can be assumed that the average emission amount corresponds to the amount of carbon dioxide (predicted emission amount) that is predicted to be emitted when the delivery vehicle 20 delivers the purchased product. Therefore, the control unit 301 can grasp the predicted emission amount of each delivery company by acquiring the average emission amount of each delivery company in the delivery company information.

Flow of Information Processing

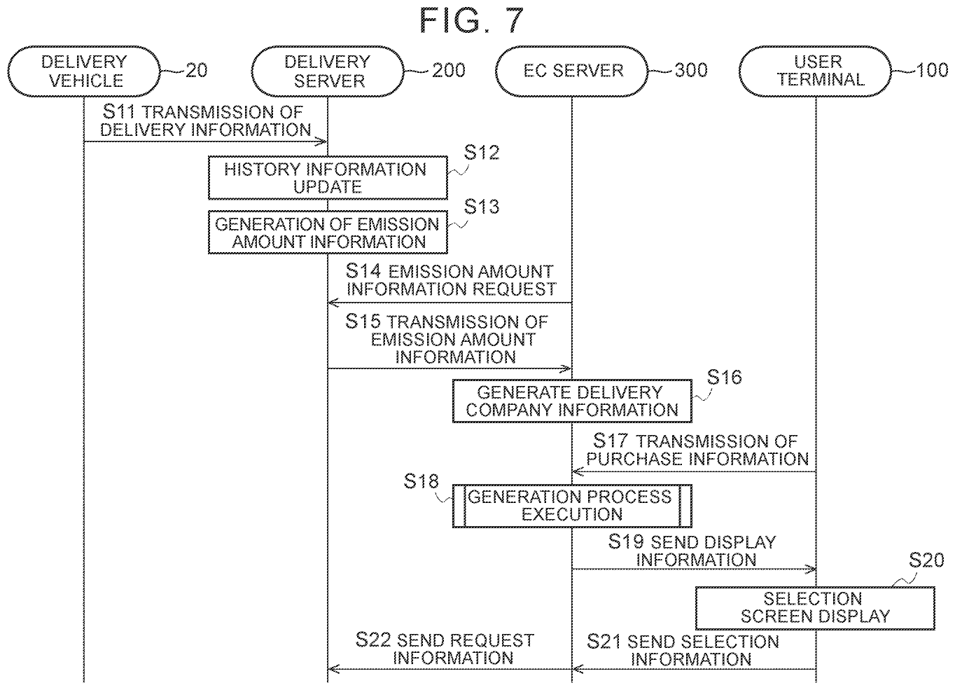

Next, the flow of information processing in the delivery system 1 will be described with reference to FIG. 7. FIG. 7 is a sequence diagram illustrating a flow of information processing in the delivery system 1. Each process executed by the user terminal 100 is executed by a control unit in the user terminal 100. Each process executed by the delivery vehicle 20 is executed by a control unit in the delivery vehicle 20. Each process executed by the delivery server 200 is executed by the control unit 201 in the delivery server 200. The respective processes executed by EC server 300 are executed by the control unit 301 in EC server 300.

As illustrated in FIG. 7, the delivery vehicle 20 transmits delivery data to the delivery servers 200 that manage the delivery vehicle 20 (S11). Next, based on the delivery information received from the delivery vehicles 20, the delivery servers 200 update the history information and store the history information in the history information DB 203 (S12). Next, based on the history information held in the history information DB 203, the delivery servers 200 generate the discharge amount information and store the emission amount information in the emission amount information DB 204 (S13).

EC server 300 requests the delivery server 200 to transmit the emissions amount information (S14). Specifically, EC server 300 transmits information for requesting transmission of the emission amount information to the delivery server 200. In this way, EC servers 300 request to transmit the emission amount data. In response to the request, the delivery servers 200 transmit the emission amount information to EC servers 300 (S15). Next, the EC server 300 generates delivery company information based on the emission amount information received from the delivery servers 200, and stores the delivery company information in the delivery company information DB 303 (S16). Here, EC servers 300 periodically transmit the emission amount data at predetermined intervals. Accordingly, EC servers 300 can generate the delivery company information on the basis of the latest emission amount information.

The user terminal 100 transmits the purchasing data to EC servers 300 (S17). Here, the purchase information is information on a commodity that the user 10 intends to purchase at EC website. The purchasing data includes a user ID of the user 10. Upon receiving the purchasing data from the user terminal 100, EC servers 300 execute a generation process (S18). The generation process is a process for generating display information. Details of the generation processing will be described later.

When the generation process is completed, EC servers 300 transmit the display-information generated in the generation process to the user terminal 100 (S19). Next, a selection window is displayed based on the display data received by the user terminal 100 (S20). Based on the selection screen displayed on the user terminal 100, the user 10 selects a delivery company that requests delivery of the purchased product. When the user 10 selects a delivery company, the user terminal 100 transmits the selection to the EC server 300 (S21). Here, the selection information includes the delivery company ID of the delivery company to which the user 10 requests delivery of the purchased product. Therefore, the EC server 300 transmits the request information to the delivery server 200 managed by the delivery company that the user 10 requests to deliver the purchased product based on the received selection information (S22). Here, the request information is information for requesting delivery of the purchased product to the user 10.

Generation Process

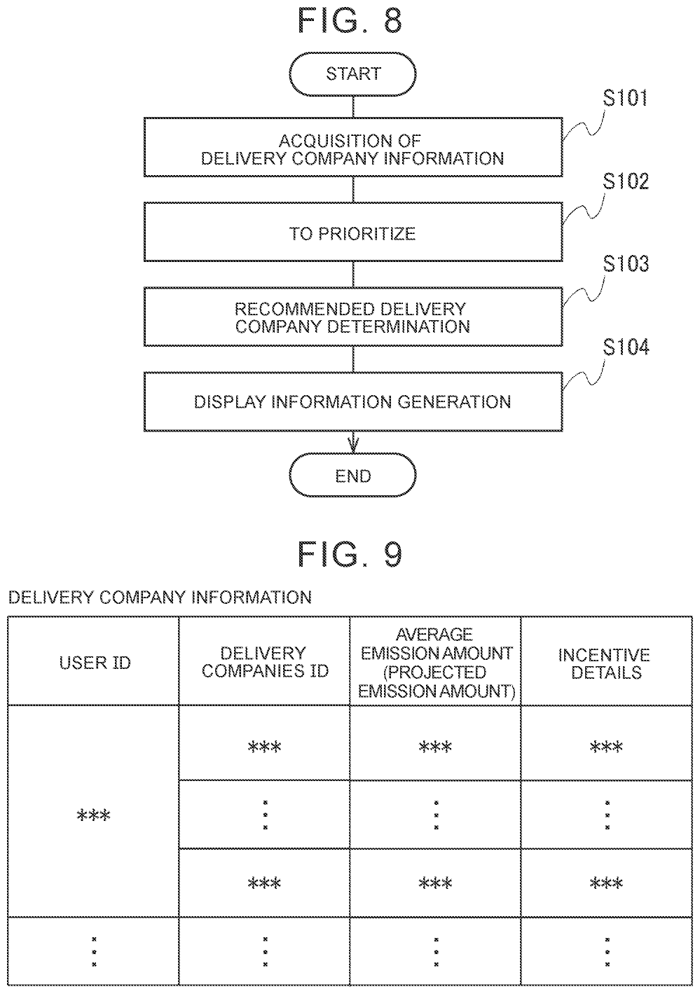

Next, a generation process executed by the control unit 301 in EC server 300 in the delivery system 1 will be described with reference to FIG. 8. Execution of the generation process is started when the EC server 300 receives the purchase information from the user terminal 100. FIG. 8 is a flowchart of a generation process.

In the generation process, first, in S101, the delivery company information is acquired from the communication unit 302. Next, in S102, the order (priority order) of the delivery companies to be preferentially displayed on the selection screen is determined based on the mean emission amount (predicted emission amount) in the delivery company information. Next, in S103, a delivery company (recommended delivery company) that is recommended to request delivery of the purchased product is determined based on the mean emission amounts (predicted emission amounts) in the delivery company information. Next, in S104, the indication is generated based on the priorities and the recommended delivery companies determined in S102 and S103. Then, the generation process is ended.

As described above, the delivery system 1 generates the display information based on the predicted emission amount. In the display information, an incentive that is preferentially displayed on the display screen is given to the delivery company in accordance with the predicted emission amount. In addition, an incentive is given to a delivery company having the smallest predicted emission amount to be proposed as a delivery company that recommends requesting delivery of a purchased product. Therefore, it is possible to encourage the plurality of delivery companies to take measures to suppress the amount of carbon dioxide discharged for delivery of the goods by the delivery vehicle 20. As a result, the amount of carbon dioxide discharged by the delivery of the purchased product by the delivery vehicle 20 can be suppressed.

### MODIFIED EXAMPLES

In the present embodiment, the delivery server 200 receives the delivery information from the delivery vehicle 20 and generates the emission amount information. However, the delivery server 200 may not necessarily receive the delivery information from the delivery vehicle 20 and generate the emission amount information. For example, instead of the delivery server 200, EC server 300 may directly receive the delivery information from the delivery vehicles 20 managed by the respective delivery companies to generate the emission amount information. In this instance, EC servers 300 further include a history information database and an emission amount information database.

Further, in the present embodiment, EC servers 300 acquire the mean emission amounts as the predicted emission amounts. However, EC servers 300 do not necessarily have to acquire the mean emission amounts as the predicted emission amounts. EC servers 300 can obtain the predicted emission amounts in a known manner.

### Second Embodiment

In the present embodiment, an incentive is given to the user 10 who selects the delivery company based on the predicted emission amount. Hereinafter, differences from the first embodiment will be described.

FIG. 9 is a diagram illustrating an exemplary table configuration of the delivery company information held in the delivery company information DB 303 according to the present embodiment. As shown in FIG. 9, the delivery company information includes a user ID field, a delivery company ID field, a predicted emission amount field, and an incentive-content field. The information entered in the user ID field, the delivery company ID field, and the predicted emission amount field is the same as that in the first embodiment, and thus the description thereof will be omitted.

In the incentive content field, the content of the incentive given to the user when the user 10 selects the delivery company of the delivery company ID entered in the delivery company ID field corresponding to the incentive content field as the delivery company requesting delivery is input.

In the present embodiment, the user may be awarded an incentive that can be used at an EC website. Note that the incentive given to the user may be, for example, a discount accepted when purchasing a product at an EC website. The incentive granted to the user may be, for example, a point or a discount available in another service.

In the incentive content field in the delivery company information, the content of the incentive is input so that the smaller the predicted emission amount corresponding to the incentive content field is, the greater the incentive is given. Specifically, the lower the projected emission amounts, the more points that can be used at EC sites. Accordingly, when the user 10 selects a delivery company having a smaller predicted emission amount as a delivery company requesting delivery of the purchased product, more incentives can be given.

In the present embodiment, the control unit 301 generates display information for displaying the contents of the incentive given to the user 10 on the selection screen based on the delivery company information. Specifically, the control unit 301 acquires the contents of the incentive input in the incentive contents field in the delivery company information for each delivery company, and generates display information.

Based on the selection information received from the user terminal 100 and the delivery company information held in the delivery company information DB 303, the control unit 301 specifies the content of the incentive to be given to the user 10. The control unit 301 generates incentive information indicating an incentive given to the user 10 based on the content of the specified incentive. Then, the control unit 301 transmits the incentive information to the user terminal 100. Accordingly, the control unit 301 can give an incentive to the user 10. Incentive information in the present embodiment corresponds to “first information” according to the present disclosure.

Granting Process

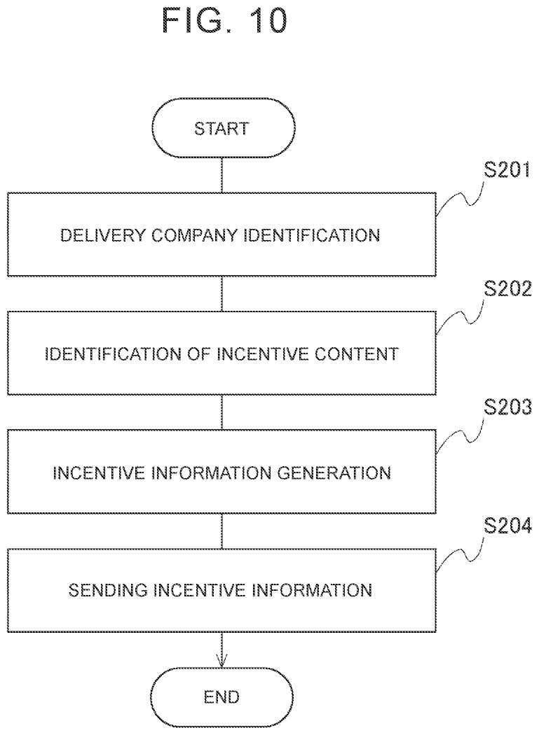

Next, an application process executed by the control unit 301 in the delivery system 1 will be described with reference to FIG. 10. The granting process is a process for granting an incentive to the user 10. The application process is started when EC servers 300 receive the selection data from the user terminals 100. FIG. 10 is a flowchart of the assigning process.

In the application process, first, in S201, the control unit 301 acquires the delivery company ID included in the selection data to identify the delivery company selected by the user 10. Next, in S202, the control unit 301 identifies the content of the incentive based on the delivery company information held in the delivery company information DB 303. Next, in S203, the control unit 301 generates the incentive information based on the content of the identified incentive information. Next, in S204, the control unit 301 transmits the generated incentive-information to the user terminal 100. Then, the assigning process is ended.

As described above, the delivery system 1 transmits the incentive information to the user terminal 100 based on the predicted emission amount of the delivery company selected by the user 10. Accordingly, it is possible to prompt the user 10 to select a delivery company having a small predicted emission amount. As a result, the amount of carbon dioxide discharged by the delivery of the purchased product by the delivery vehicle can be suppressed.

### Other Embodiments

The above-described embodiments are mere examples, and the present disclosure can be implemented with appropriate modifications within a range not departing from the scope thereof. Moreover, the processes and units described in the present disclosure can be freely combined and implemented unless technical contradiction occurs.

Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function.

The present disclosure can also be implemented by supplying a computer with a computer program that implements the functions described in the above embodiments, and causing one or more processors of the computer to read and execute the program. Such a computer program may be provided to the computer by a non-transitory computer-readable storage medium connectable to the system bus of the computer, or may be provided to the computer via a network. Examples of the non-transitory computer-readable storage medium include a random disk (such as a magnetic disk (a floppy□ disk an HDD, and the like) or an optical disc (such as a CD-ROM, a DVD disc, and a Blu-ray disc)), a ROM, a RAM, an EPROM, an EEPROM, a magnetic card, a flash memory, an optical card, and a random type of medium suitable for storing electronic instructions.

What is claimed is:

1. An information processing device comprising a control unit configured to generate first information including an incentive given to at least one of a plurality of delivery companies or an incentive given to a predetermined user based on an emission amount, wherein the emission amount is an amount of carbon dioxide that is expected to be emitted when each of the delivery companies delivers a product to the predetermined user by a vehicle.

2. The information processing device according to claim 1, wherein the control unit is configured to transmit information on the emission amount of each of the delivery companies to a terminal related to the predetermined user when a delivery company to which the predetermined user requests delivery of the product is selected from among the delivery companies.

3. The information processing device according to claim 1, wherein the incentive given to the at least one of the delivery companies includes that the incentive is preferentially displayed on a screen in which the predetermined user selects a delivery company for delivering the product from among the delivery companies.

4. The information processing device according to claim 3, wherein the incentive given to the at least one of the delivery companies includes that the delivery company to which the incentive is given is displayed above other delivery companies on the screen.

5. The information processing device according to claim 3, wherein the incentive given to the at least one of the delivery companies includes that the delivery company to which the incentive is given is displayed at a larger size than other delivery companies on the screen.

6. The information processing device according to claim 1, wherein the incentive given to the at least one of the delivery companies includes that the incentive is proposed as a delivery company that is recommended for the predetermined user to request delivery of the product.

7. The information processing device according to claim 1, wherein the incentive given to the predetermined user is given more when the predetermined user selects a delivery company having a smaller emission amount.

8. An information processing method executed by a computer, the information processing method comprising generating first information including an incentive given to at least one of a plurality of delivery companies or an incentive given to a predetermined user based on an emission amount, wherein the emission amount is an amount of carbon dioxide that is expected to be emitted when each of the delivery companies delivers a product to the predetermined user by a vehicle.

9. The information processing method according to claim 8, further comprising transmitting information on the emission amount of each of the delivery companies to a terminal related to the predetermined user when a delivery company to which the predetermined user requests delivery of the product is selected from among the delivery companies.

10. The information processing method according to claim 8, wherein the incentive given to the at least one of the delivery companies includes that the incentive is preferentially displayed on a screen in which the predetermined user selects a delivery company for delivering the product from among the delivery companies.

11. The information processing method according to claim 10, wherein the incentive given to the at least one of the delivery companies includes that the delivery company to which the incentive is given is displayed above other delivery companies on the screen.

12. The information processing method according to claim 10, wherein the incentive given to the at least one of the delivery companies includes that the delivery company to which the incentive is given is displayed at a larger size than other delivery companies on the screen.

13. The information processing method according to claim 8, wherein the incentive given to the at least one of the delivery companies includes that the incentive is proposed as a delivery company that is recommended for the predetermined user to request delivery of the product.

14. The information processing method according to claim 8, wherein the incentive given to the predetermined user is given more when the predetermined user selects a delivery company having a smaller emission amount.

15. A non-transitory storage medium storing a program for causing a computer to execute an information processing method, the information processing method comprising generating first information including an incentive given to at least one of a plurality of delivery companies or an incentive given to a predetermined user based on an emission amount, wherein the emission amount is an amount of carbon dioxide that is expected to be emitted when each of the delivery companies delivers a product to the predetermined user by a vehicle.

16. The storage medium according to claim 15, wherein the information processing method further includes transmitting information on the emission amount of each of the delivery companies to a terminal related to the predetermined user when a delivery company to which the predetermined user requests delivery of the product is selected from among the delivery companies.

17. The storage medium according to claim 15, wherein the incentive given to the at least one of the delivery companies includes that the incentive is preferentially displayed on a screen in which the predetermined user selects a delivery company for delivering the product from among the delivery companies.

18. The storage medium according to claim 17, wherein the incentive given to the at least one of the delivery companies includes that the delivery company to which the incentive is given is displayed above other delivery companies on the screen.

19. The storage medium according to claim 15, wherein the incentive given to the at least one of the delivery companies includes that the incentive is proposed as a delivery company that is recommended for the predetermined user to request delivery of the product.

20. The storage medium according to claim 15, wherein the incentive given to the predetermined user is given more when the predetermined user selects a delivery company having a smaller emission amount.
